(19) United States
(12) Patent Application Publication
(10) Pub. No.: US 2021/0165678 A1
(43) Pub. Date: Jun. 3, 2021

(54) LANGUAGE-SPECIFIC DOWNSTREAM WORKFLOWS

(71) Applicant: Hewlett-Packard Development Company, L.P., Spring, TX (US)

(72) Inventors: A. Marie Vans, Fort Collins, CO (US); Steven J. Simske, Fort Collins, CO (US)

(73) Assignee: Hewlett-Packard Development Company, L.P., Spring, TX (US)

(21) Appl. No.: 16/770,395

(22) PCT Filed: Jan. 29, 2018
(86) PCT No.: PCT/US2018/015708

§ 371 Date: Jun. 5, 2020

(51) Int. Cl. G06F 9/48; G06F 40/58; G06F 40/263; G06K 9/00; G06F 16/953; G06F 16/9538

(52) U.S. Cl. CPC G06F 9/485; G06F 40/58; G06F 16/9538; G06K 9/00671; G06F 16/953; G06F 40/263

(57) ABSTRACT

A method for providing workflows includes capturing an image of an information-carrying component of a workflow object. The method also includes determining a language of the workflow object based on the captured image. The method additionally includes determining that the language of the workflow object is different from a language context of the device. Further, the method includes generating a workflow based on the information-carrying component, the language of the workflow object, and the language context. The workflow generates additional information for the information-carrying component.

### BACKGROUND

Virtual reality (VR) is a technology that provides an immersive viewing experience that typically supplants the user's view of the real world. Virtual reality applications may enable the user to move about and manipulate virtual items in a computer-generated, virtual environment, such as a barren Martian landscape. Augmented and mixed-reality (AR and MR) technologies, on the other hand, may provide the user with a view of the real world that is augmented with computer-generated information or images. An example AR application may augment the viewer's knowledge of local business. In such an application, when a storefront is viewed through an AR device, the display may show a view of the store, alongside background information about the business, such as, the days and hours that the store is open.

### BRIEF DESCRIPTION OF THE DRAWINGS

Certain examples are described in the following detailed description and in reference to the drawings, in which:

FIG. 1 is a simplified diagram of a system for language-specific downstream workflows, according to some examples.

FIG. 2 is a simplified diagram of example language-specific downstream workflows, according to some examples.

FIG. 3 is a simplified diagram of example language-specific downstream workflows, according to some examples.

FIG. 4 is a simplified diagram of example language-specific downstream workflows, according to some examples.

FIG. 5 is a flow diagram illustrating a method for language-specific downstream workflows, according to examples.

FIG. 6 is a simplified diagram of a computer-readable media for language-specific downstream workflows, according to examples.

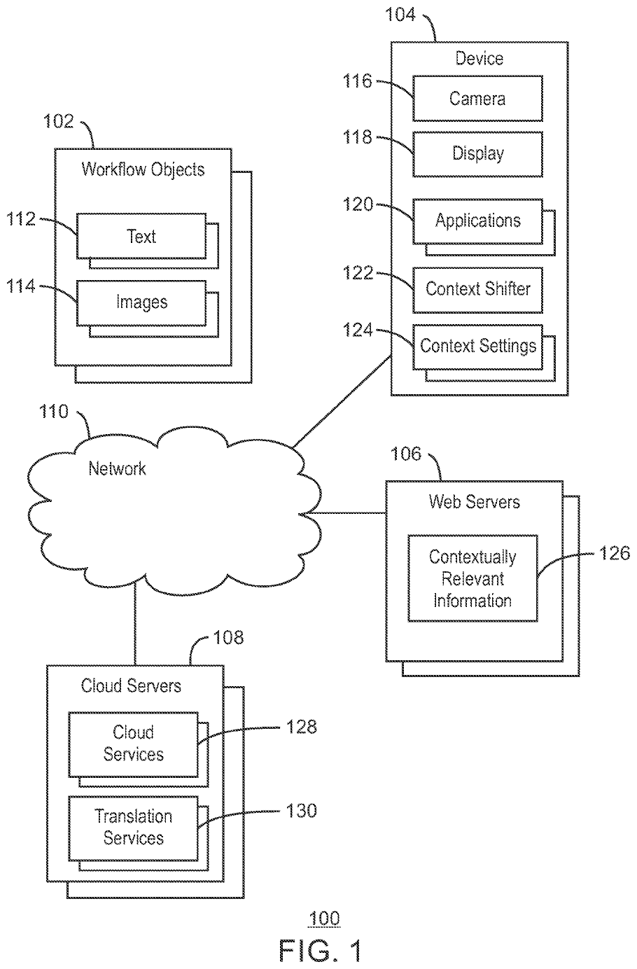

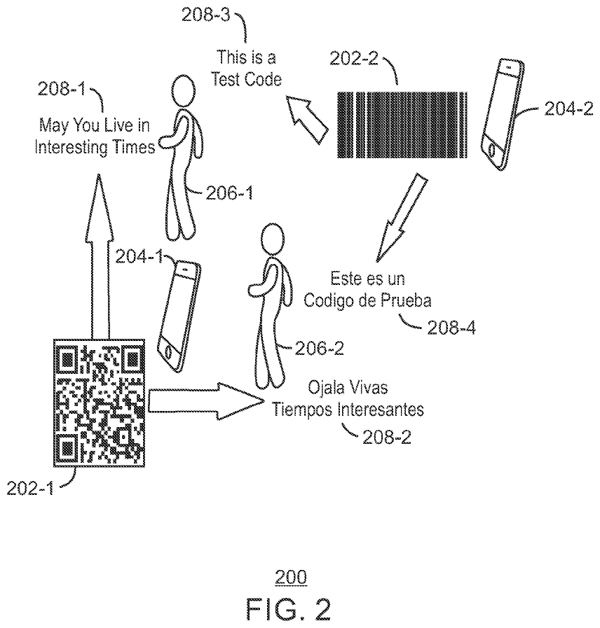

The same numbers are used throughout the disclosure and the figures to reference like components and features. Numbers in the 100 series refer to features originally found in FIG. 1, numbers in the 200 series refer to features originally found in FIG. 2, and so on.

### DETAILED DESCRIPTION

While the advent of virtual, augmented, and mixed-reality technologies may provide many possibilities with regard to what kind of environments are created, these environments may present the viewer with information that inspires the viewer onto a downstream workflow. The downstream workflow is a workflow that is performed later within a series of workflows. In this example of VR, AR, and MR environments, the downstream workflow may be a sequence of steps that are performed outside of the workflow that is directing the generation of the VR, AR, and MR environment. For example, the viewer of an AR environment may be looking at a list of ingredients on a food label. One of the ingredients may not be familiar to the viewer. In such a scenario, the viewer may want to do an Internet search on the unknown ingredient. The Internet search is the downstream workflow.

However, an Internet search as described above is not useful to the searcher unless the information found is presented in a language that the viewer understands. One possible approach to providing language-specific information in the downstream workflow would be to use an online language translation service. However, this approach may be inefficient and disruptive due to the addition of another workflow. Further, the additional workflow (calling the translation service) may be a manual process performed by the viewer, which may diminish the viewer's experience.

In examples, viewers may be provided with downstream workflows that present information on a device in a language the viewer understands. The language may be determined according to the device location, or by designation in the settings of the device. This means that regardless of the original language associated with an object, the information associated with the object is presented to the viewer in a language the viewer may understand.

FIG. 1 is a simplified diagram of a system 100 for language-specific downstream workflows, according to some examples. The system 100 includes a workflow object 102, a device 104, Web servers 106, cloud servers 108, and network 110. The workflow object 102 may be any of a broad variety of objects that may be incorporated within a workflow. A workflow is series of tasks that may be performed for a specific object. For example, if an example workflow object 102 is an express delivery package, one possible workflow for a delivery service may specify the series of tasks for delivering the package to its addressee. The Web servers 106 may host information that may be searched by downstream workflows, as described in greater detail below. The cloud servers 108 may provide services to the device 104, such as cloud services 128 and translation services 130. The cloud services 128 may provide various functionality for the downstream workflows to access. In some examples, the cloud services 128 may use a database that contains additional information that is relevant to the selected information-carrying component. The database may be local to the cloud server 108 or the device 104.

The workflow object 102 includes text 112 and images 114. The text 112 may include a variety of information, such as a Website address, a manufacturer mailing address, standards related to the workflow object 102, and so on. The text 112 and images 114 may be printed, labeled, or otherwise made viewable on the workflow object 102. The text 112 and images 114 may describe the workflow object 102, an associated object, the object's manufacturer, and so on. In some examples, the text 112 or images 114 may be encoded in a machine-generated bar code, such as the quick response code (QR) and the Universal Product Code (UPC). Because each of the text 112 and images 114 convey information to the viewer, the text 112 and images 114 are also referred to herein as information-carrying components.

The device 104 includes a camera 116, display 118, applications 120, context shifter 122, and context settings 124, and may be a computing device used to present a virtual, augmented, or mixed reality environment on the display 118. Examples of the device 104 include a smartphone or a tablet, which may have the display 118 integrated with the device 104. Alternatively, for VR, AR, or MR environments generated on devices 104 such as, laptops, servers, or desktop computers, the display 118 may be separate electronic device from the device 104. The applications 120 may include software that generates VR, AR, or MR environments, a Web browser, and any software applications that may be used to retrieve additional information about information-carrying components. In one example, an AR application may use the camera 116 to capture a view of the object 102, and show the view on the display 118. The example AR application may generate text or images to augment the view of the object 102.

The device 104 performs language-related tasks based on the context. In one context, the viewer may be handling a product to which the shipping label is attached. In such a context, the device 104 may invoke cloud services 128 that are package-related to perform inventory and distribution activities, for example. Thus, when the device 104 is determined to be interacting with the package itself, the language printed on the package and other contextual settings of the package are used when determining how to present information to the viewer. However, the context shifts when the device 104 is determined to be interacting with the information-carrying components on the object 102. In such an event, the context shifter 122 may be launched to generate the downstream workflow indicated by the viewer's selection. Additionally, the context shifter 122 may generate downstream workflows that provide information based on the context settings 124. The context settings 124 may identify one or more contextual variables for the device, such as a language, a location of the device 104, and so on. The context settings 124 may specify the language expressly, for example, the context settings 124 may indicate the language context for the device 104 is English. Alternatively, the language context may be determined based on the context setting 124 of location. For example, the native language of the geographical region represented in the location may be used as the language for the device 104. Accordingly, the device 104 may present information generated by the downstream workflows in the context of a language that the viewer understands. In this way, the device 104 enters a new context in response to the selection of a single information-carrying component on the object 102 for additional information.

In some examples, the context settings 124 may specify a database that may be used by a cloud service 128 to translate an information-carrying component to the language context. An example database may specify a code translation from a code label on packaging to a definition of the code, which may be provided in the additional information.

In some examples, the context shifter 122 may invoke a cloud service 128, such as a cultural awareness service, that may analyze an image 114 for potentially offensive content based on the context settings 124. Such a service may also flag the image to be censored. In such examples, the context shifter 122 may remove the potentially offensive image from the additional information. Alternatively, the context shifter 122 may use predetermined censorship policies to determine whether or not to censor content, and how the content may be censored. For example, as an alternative to being removed from the additional information, an offensive image may be replaced or greyed out depending on the policy.

In examples, the viewer may select an information-carrying component for additional information by placing the component at the center of the display 118, and pressing a selection button (not shown) that may be on the device 104, or may be located on a peripheral controller (not shown) the viewer uses to manipulate the VR, AR, and MR environments. The additional information provided by the downstream workflows may vary based on the downstream applications 120 available. In some examples, the request for additional information may be a simple network, e.g., Internet, search for a term printed on the object 102. The Internet search may be performed by a Web browser application. The results of such a search may be presented to the viewer in the language context indicated by the context settings 124. Additionally, a wholesaler or retailer selling a product to which the shipping label is attached, may provide applications 120 that enable the viewer to enter rewards programs that reward customers for purchases, programs that enable the company to track the product, and so on. As such, when the selection for additional information occurs, a downstream workflow may be generated that launches the application for joining the rewards program, for example. In some examples, a workflow may be generated to launch an application 120 that is written in the language context for the device 104 indicated by the context settings 124. If an application 120 for the specific language is not available, the downstream workflow may include a call to the translation services 130 to translate any output generated by the downstream workflow to the language for the device 104.

Additionally, the AR application may invoke the context shifter 122 if an information-carrying component is queried for additional information. The context shifter 122 may be an application that generates downstream workflows that provide the additional information requested by the viewer in a language that is based on the context settings 124. For example, a workflow object 102, such as a shipping label, may include a QR code that encodes an English language description of an item being shipped. However, the context settings 124 may indicate that the device 104 is in Mexico. Accordingly, the context shifter 122 may determine that the language context for a device 104 located in Mexico is Spanish. Thus, the context shifter 122 may generate a downstream workflow that decodes the QR code, translates the English language description to Spanish, and presents the Spanish translation on the display 118. Alternatively, the device 104 may have a language designation expressly set in the context settings 124. In such a scenario, any additional information provided by downstream workflows is provided in the same language, regardless of the location of the device 104. The context shifter 122 may also generate workflows that launch an application 120 in response to requests for additional information about an information-carrying component. The launched application 120 may be a Web browser that is launched to perform a network search for an information-carrying component. Referring back to the example of viewing a list of ingredients on a food label described above, the viewer may make a selection for additional information on one of the ingredients. In response, the context shifter 122 may generate a downstream workflow that launches the Web browser to perform the search, and provides the search results on the display based on the language context indicated in the context settings 124. The search results may include contextually relevant information 126 retrieved from Web servers 106 on the network. Web servers 106 provide the content of the World Wide Web. The search may search these Web servers 106 for contextually relevant information 126 that is contextually relevant to the selected information-carrying component. Additionally, the workflow may provide the search results in a language context that is determined based on the context settings 124.

In addition to the context of language, the context settings 124 may also indicate the unit system with which any measurements provided by a downstream workflow are described. For example, the context settings 124 may indicate that the unit system for the device is metric. Thus, if an information-carrying component describes measurements using the Imperial system (units of inches, feet, pounds, etc.), the context shifter 122 may generate a downstream workflow that converts the measurements to metric units before the measurements are presented on the display 118.

FIG. 2 is a simplified diagram of language context shifting for downstream workflows, according to some examples. In this diagram, a QR code 202-1 and a UPC 202-2 are information-carrying components on a packaging object that may be scanned by devices 204-1, 204-2, respectively. The devices 204-1, 204-2 may be mobile computing devices, such as device 104 described with respect to FIG. 1. Referring back to FIG. 2, in this example, the devices 204-1, 204-2 have context settings, such as context settings 124, which indicate the language context for the devices 204-1, 204-2 is Spanish. However, as indicated by the arrows from the barcodes 202-1, 202-2 to the decoded messages 206-1, 206-2, the barcodes 202-1, 202-2 are both encoded with English language messages. Accordingly, in examples, the devices 204-1, 204-2 may execute an application, such as one of the applications 120, to decode the barcodes' English language messages. Further, the devices 204-1, 204-2 may call a translation service, such as translation service 130, to translate the messages 206-1, 206-2 to Spanish, and present the translations 208-1, 208-2 on a display, such as display 118. Referring back to FIG. 2, the devices 204-1, 204-2 may thus present the message encoded in the barcodes 202-1, 202-2 in the languages for the devices 204-1, 204-2. In this example, both devices 204-1, 204-2 have Spanish as the language. However, the languages may vary across devices.

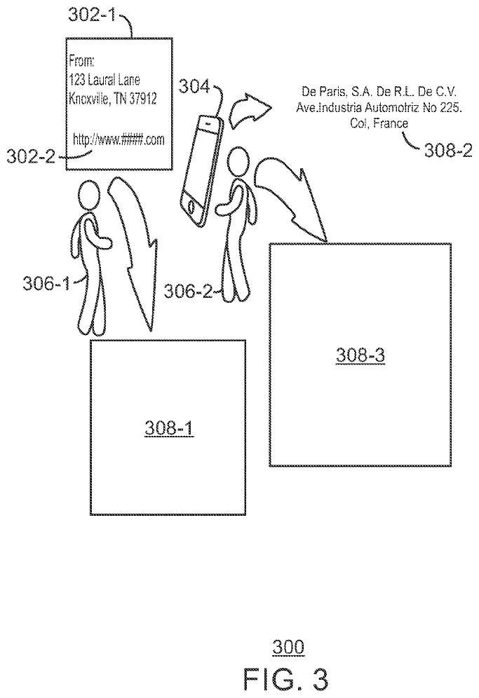

FIG. 3 is a simplified diagram of location context shifting for downstream workflows, according to some examples. In this example, a shipping label object (not shown) may include information-carrying components 302-1, 302-2, which may both be read by devices 304-1, 304-2 with context settings 306-1, 306-2. The devices 304-1, 304-2 may be computing devices, such as device 104, described with respect to FIG. 1. Referring back to FIG. 3, the information-carrying component 302-1 may be a U.S. address that may be used for correspondence with English-speaking customers. Additionally, the information-carrying component 302-2 may be a uniform resource locator (URL) for a company Web page that serves English-speaking customers. In this example, the context setting 306-1 for the location of the device 304-1 may be the United States. As such, the URL may be selected for additional information, i.e., a downstream workflow to generate additional information regarding the URL. In such a case, the downstream workflow may launch a Web browser, which may open the Web page at the URL, http://www.###.com.

With respect to device 304-2, however, the context setting 306-2 may indicate the device 304-2 is in France. As such, if the U.S. address in the information-carrying component 302-1 is selected for additional information, the device 304-2 may generate a downstream workflow that displays an address 308-2 in France for corresponding with the company's French customers. With respect to the information-carrying component 302-2, as stated previously, the Web page is for English-speakers, not French speakers. However, the company may have an alternate version of their Web site in the French language. Thus, if the URL is selected for additional information, the device 304-2 may launch the Web browser to open a Web page on the French language Web site using a French language URL. In cases such as these, where an alternate piece of information may be provided as additional information, e.g., the alternate URL, an application 120 may determine the alternates by querying a database table, either local to the device 304-2, or through a cloud service 128.

In another example, the context settings 124 may indicate that the French language be used regardless of the device's location. Accordingly, Jacques from Quebec City whose smartphone has context settings 124 indicating the language for the device 104 is French, may be provided the French language Web site when the English language URL is selected, whether Jacque is carrying his device 104 in the U.S. or Quebec.

Translation is one form of deriving meaning from textual information that is unfamiliar to the viewer. Another way that the viewer may derive meaning from unfamiliar information is by requesting additional information as described herein. In some examples, requesting additional information may help the viewer to derive meaning from graphic information, such as technical symbols, logos, and so on.

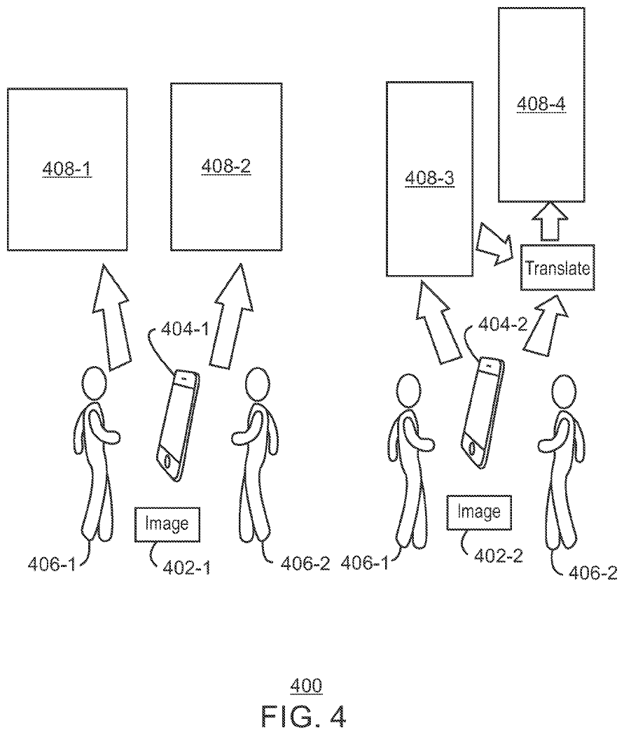

FIG. 4 is a simplified diagram of symbol context shifting in downstream workflows, according to some examples. In this example, a workflow object (not shown) may include images 402-1, 402-2, which may both be read by devices 404-1, 404-2 with context settings 406-1, 406-2. The downstream workflows may generate additional information, such as Web pages 408-1 to 408-3. Alternatively, the downstream workflows may generate language-specific versions 408-4 of Web pages that are translations of the Web pages from a different language, as described in greater detail below. The images 402-1, 402-2 may include technical symbols, logos, or any information-carrying component that conveys information graphically. The context setting 406-1 may indicate the language context for the device 404-1 is English. As such, when the viewer requests additional information on the image 402-1, the viewer may be provided an English-language Web page 408-1 found in an Internet search. However, in another scenario, the context setting 406-2 may indicate the language context for the device 404-1 is Spanish. Accordingly, the viewer may be provided a Spanish-language Web page 408-2 found in an Internet search.

Similarly for the other image 402-2, when additional information is requested from the device 404-2 with the English-language context setting 406-1, the viewer may be provided with an English-language Web page 408-3 found in a search result. However, there may be scenarios where a language-specific search result may not be available. In such a scenario, information found in a search result may be translated in real-time to the language for the device 404-2. For example, when additional information is requested for image 402-2, and the device 404-2 has a Spanish-language context setting 406-2, the English-language Web page 408-3 may be translated to generate a Spanish-language Web page 408-4. In such a scenario, the context shifter 122 may invoke the translation service 130 to generate the translation.

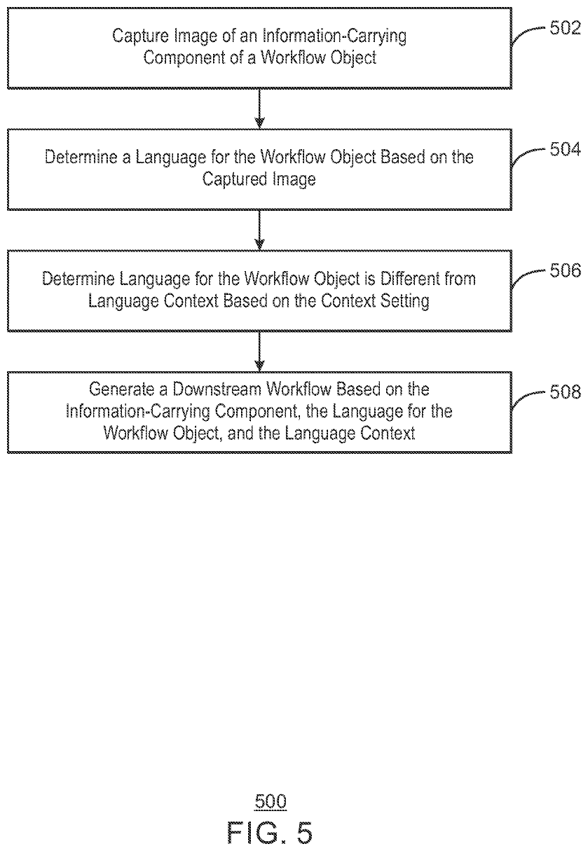

FIG. 5 is a flow diagram illustrating a method 500 for language-specific downstream workflows, according to examples. In examples, the method 500 may be performed by the context shifter 122. At block 502, the context shifter 122 may capture an image of an information-carrying component (ICC) of a workflow object 102 in response to a request for additional information about the component. In examples, the workflow object 102 may include the packaging of a consumer product, which may include images of the product and a list of ingredients. While looking through the list of ingredients, the viewer may make an express selection of one of the ingredients. In response, the context shifter 122 may direct the camera 116 to capture an image of the selected text for the ingredient.

At block 504, the context shifter 122 may determine the language of the workflow object 102 based on the captured image. In examples, the context shifter 122 may call a cloud service 128, such as an optical character recognition service, to identify the text, and a translation service 130 to determine the language. In this way, the context shifter 122 may determine the language for the workflow object 102.

At block 506, the context shifter 122 may determine that the language for the workflow object 102 is different from the language context based on the context settings 124. For example, the context settings 124 may indicate that the language context for the device 104 is based on location. As such, if the context settings 124 indicate the device 104 is located in Quebec, the French language may be determined as the language for the device 104. On the other hand, if the context settings 124 indicate the device 104 is located in Mexico, the Spanish language may be determined as the language for the device 104. In another example, the context settings may indicate that the French language is to be used for the device 104 regardless of the device's location. Accordingly, Jacques from Quebec City whose smartphone has context settings 124 indicating the language for the device 104 is French, may be provided the requested additional information in French, whether the device 104 is in the U.S. or Quebec.

At block 508, the context shifter 122 may generate a downstream workflow based on the information-carrying component, the language for the workflow object 102, and the language context. In examples, the downstream workflow may be a series of processes determined by the context shifter 122 to provide the additional information for the requested information-carrying component. The processes may involve specific functions that use the selected information-carrying component as input. For example, if the viewer selects an ingredient printed on a food label for additional information, the downstream workflow may execute an Internet search using the selected ingredient. Further, the downstream workflow may display Web pages found in the search using the language of the device 104. Thus, Web pages in the device language may be presented to the viewer. Alternatively, the downstream workflow may invoke a translation service 130 to generate a version of the Web pages in the device language from Web pages in a different language. In this way, the context shifter 122 may provide the viewer with language-specific downstream workflows that present requested information to the viewer in a language the viewer understands.

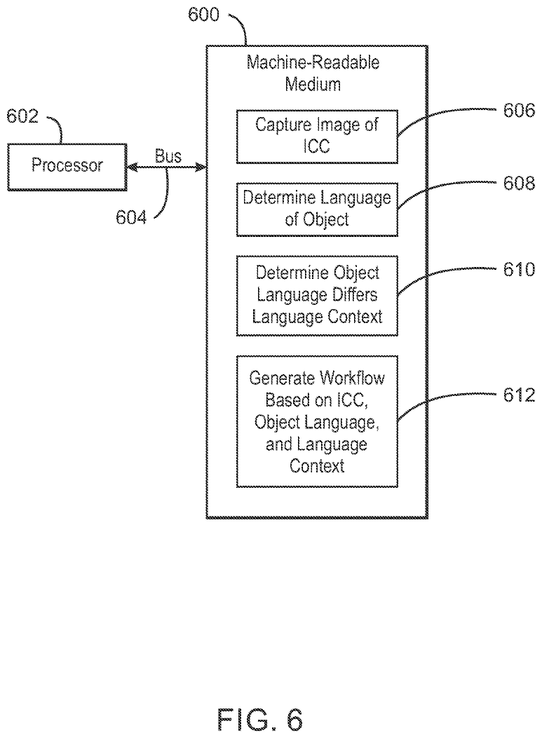

FIG. 6 is a block diagram of an exemplary non-transitory, machine readable medium 600 including code or instructions to direct a processor 602 to perform the operations of the context shifter 122 of FIG. 1. The processor 602 may access the non-transitory, machine readable medium 600 over a bus 604. The non-transitory, machine readable medium 600 may include devices for storage or may include optical disks, thumb drives, or any number of other hardware devices.

The non-transitory, machine readable medium 600 may include code 606 to direct the processor 602 to capture an image of an information-carrying component of a workflow object. The non-transitory, machine readable medium 600 may also include code 608 to direct the processor 602 to determine the language of the information-carrying component. Additionally, the non-transitory, machine readable medium 600 may include code 610 to direct the processor 602 to determine the language of the workflow object 102 is different from the language of the device. Further, the non-transitory, machine-readable medium 600 may include code 610 to direct the processor 602 to generate a downstream workflow based on the information-carrying component, the language of the workflow object 102, and the language for the device 104.

In low power implementations, the storage 608 may be on-die memory or registers associated with a processor. However, in some examples, the storage 608 may be implemented using a micro hard disk drive (HDD). Further, any number of new technologies may be used for the storage 608 in addition to, or instead of, the technologies described, such resistance change memories, phase change memories, holographic memories, or chemical memories, among others.

While the present techniques may be susceptible to various modifications and alternative forms, the techniques discussed above have been shown by way of example. It is to be understood that the technique is not intended to be limited to the particular examples disclosed herein. Indeed, the present techniques include all alternatives, modifications, and equivalents falling within the scope of the following claims.

What is claimed is:

1. A method for providing workflows, comprising:
capturing, using a device, an image of an information-carrying component of a workflow object;
determining a language of the workflow object based on the captured image;
determining that the language of the workflow object is different from a language context based on a context setting for the device; and
generating a workflow based on the information-carrying component, the language of the workflow object, and the language context, wherein the workflow generates additional information for the information-carrying component.

2. The method of claim 1, wherein the workflow comprises presenting the additional information using the device.

3. The method of claim 2, wherein the workflow comprises translating the information-carrying component from the language of the workflow object to the language context.

4. The method of claim 3, wherein the workflow comprises performing a network search based on the translated information-carrying component.

5. The method of claim 3, wherein the network search is performed using a Web browser.

6. The method of claim 1, comprising executing the generated workflow.

7. The method of claim 1, wherein the workflow comprises querying an online service for the additional information.

8. The method of claim 7, wherein the information-carrying component comprises an offensive image that is flagged by the online service for censorship, and wherein the workflow comprises removing the offensive image from the additional information.

9. The method of claim 1, wherein the context setting comprise one of:
one or more predetermined languages;
one or more predetermined units of measure; or
one or more predetermined database tables.

10. The method of claim 1, wherein the device comprises one of:
a barcode reader;
a virtual reality device;
an augmented reality device;
a mobile scanning device; and
a smartphone.

11. A system for providing workflows, comprising:
a processor; and
a memory comprising instructions that cause the processor to:
capture, using a device, an image of an information-carrying component of a workflow object;
determine a language of the workflow object based on the captured image;
determine that the language of the workflow object is different from a language context of the device; and
generate a workflow based on the information-carrying component, the language of the workflow object, and the language context, wherein the workflow generates additional information for the information-carrying component requested by the device, wherein the workflow comprises presenting the additional information using the device.

12. The system of claim 11, wherein the workflow comprises translating the information-carrying component from the language of the workflow object to the language context.

13. The system of claim 12, wherein the workflow comprises performing a network search based on the translated information-carrying component.

14. The system of claim 13, wherein the network search is performed using a Web browser.

15. A non-transitory, computer-readable medium for providing workflows, comprising instructions that cause a processor to:
capture, using a device, an image of an information-carrying component of a workflow object;
determine a language of the workflow object based on the captured image;
determine that the language of the workflow object is different from a language context of the device; and
generate a workflow based on the information-carrying component, the language of the workflow object, and the language context, wherein the workflow generates additional information for the information-carrying component requested by the device, wherein the workflow comprises:
translating the information-carrying component from the language of the workflow object to the language context;
performing a network search based on the translated information-carrying component; and
presenting the additional information using the device.
